(19) United States
(12) Patent Application Publication
(10) Pub. No.: US 2002/0051867 A1
(43) Pub. Date: May 2, 2002

(54) Ink jet recording paper

(76) Inventors: Soichiro Hiraki, Chiba (JP); Kazuhiro Yamada, Chiba (JP); Takashi Kuroda, Chiba (JP); Taku Kojima, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 09/816,223

(22) Filed: Mar. 26, 2001

(30) Foreign Application Priority Data
Mar. 24, 2000 (JP) 2000-83596

(51) Int. Cl. B41M 5/00

(52) U.S. Cl. 428/195

(57) ABSTRACT

Provided is an ink jet recording paper which has appearance required for printing a photographic image and in which an inexpensive raw material is used. The ink jet recording paper described above comprises as a support, a void-containing stretched film comprising a crystalline polypropylene resin and a dicyclopentadiene type petroleum resin as essential components and an ink receiving layer formed on a surface thereof.

### BACKGROUND OF THE INVENTION

1. Field of the Invention

The present invention relates to an ink jet recording paper which has a high opacity and appearance having a glossiness of a pearl color tone and can be printed by an ink jet system and which is characterized by such clearness and smoothness that it is suitably used for reproducing photographic images.

2. Description of the Related Art

In an ink jet recording method, recording is carried out by jetting small droplets of an ink from a fine nozzle by bubble jet, thermal ink jet and piezo element methods and sticking a part or all of them on a recording medium such as paper and a plastic film coated thereon with an ink-receiving layer. Attentions are paid thereto as a method which generates less noise and can carry out high-speed printing and process color printing and which meets a small lot and is easy to output, so that it is used for various uses. In particular, a recording paper for printing photographic image informations received in the form of digital information at a high image quality through a scanner has been desired in a process of advancing to digitalization and electronization.

Various papers, PET films and cloths have so far been developed as a recording material used for ink jet recording. However, when photographic images are recorded on these recording papers, paper and cloth have large irregularities on surfaces of the base materials, and therefore there are the defects that the appearance thereof becomes canvas-like and that when a photographic image is printed thereon, the clearness is short. On the other hand, a PET film has a high smoothness but has the problem that the cost thereof is high.

Thus, desired is an ink jet recording paper which has appearance required for printing a photographic image and in which an inexpensive raw material is used.

### SUMMARY OF THE INVENTION

An object of the present invention is to provide an ink jet recording paper which has appearance required for printing a photographic image and in which an inexpensive raw material is used.

Intensive researches repeated by the present inventors have resulted in finding that the problems described above can be solved by an ink jet recording paper in which used as a support is a void-containing stretched film comprising a crystalline polypropylene resin and a dicyclopentadiene type petroleum resin as essential components and in which an ink receiving layer is formed on a surface thereof, and thus they have completed the present invention.

The present invention comprises the following structures.

(1) An ink jet recording paper comprising a void-containing stretched film comprising a crystalline polypropylene resin and a dicyclopentadiene type petroleum resin as essential components and an ink receiving layer formed on a surface thereof.

(2) The ink jet recording paper as described in the above item (1), wherein the void-containing stretched film is a void-containing laminated stretched film having an average surface roughness of 0.05 to 0.4 μm, which is obtained by laminating a surface layer film comprising a composition of the crystalline polypropylene resin at least on one face of a base layer film comprising a resin composition prepared by blending 10 to 190 parts by weight of the dicyclopentadiene type petroleum resin having a softening point (ring and ball method) of 160 to 200° C. and 10 to 190 parts by weight of an inorganic filler powder with 100 parts by weight of the crystalline polypropylene resin so that the total amount of the dicyclopentadiene type petroleum resin and the inorganic filler powder is 20 to 200 parts by weight, and then stretching it at an area magnification of 5 times or more.

### DETAILED DESCRIPTION OF THE PREFERRED EMBODIMENTS

The embodiment of the present invention shall be explained below.

In the ink jet recording paper of the present invention, the void-containing stretched film which is the support is a void (fine void)-containing single layer stretched film or a void-containing laminated stretched film obtained by stretching at an area magnification of 5 times or more, a single layer non-stretched film obtained from a resin composition (hereinafter referred to as a resin composition for a void-containing stretched film) comprising a crystalline polypropylene resin and a dicyclopentadiene type petroleum resin as essential components or a laminated non-stretched film which comprises the single layer non-stretched film described above as a base layer and in which a surface layer film comprising a composition of the crystalline polypropylene resin is laminated at least on one face of the base layer.

In the present invention, a film is a general term for a film and a sheet.

The crystalline polypropylene resin used for the resin composition for the void-containing stretched film described above and the composition (hereinafter referred to as the resin composition for the surface layer film) of the crystalline polypropylene resin for the surface layer film is a crystalline homopolymer of propylene, a binary or higher copolymer of propylene with at least one selected from ethylene and α-olefins having 4 or more carbon atoms, or a mixture thereof. To be specific, it includes propylene base polymers having a crystal melting point such as crystalline polypropylene containing a boiling heptane-insoluble part of 70% or more, preferably 80% or more, and crystalline propylene copolymers containing a propylene component of 70% or more, such as a crystalline ethylene.propylene copolymer, a crystalline propylene.1-butene copolymer, a crystalline propylene.1-hexene copolymer and a crystalline ethylene.propylene.1-butene copolymer. The crystalline polypropylene resins used for the resin composition for the void-containing stretched film and the resin composition for the surface layer film may be the same or different.

The crystalline polypropylene resin described above has a melt flow rate (measured on a condition 14 (test temperature: 230° C. and test load: 21.18 N) shown in Table 1 of JIS K-7210 ┌Flow test method of thermoplastic plastics┘, hereinafter referred as MFR) of 0.5 to 20 g/10 minutes, preferably 0.5 to 10 g/10 minutes.

The dicyclopentadiene type petroleum resin used for the resin composition for the void-containing stretched film described above has preferably a softening point (ring and ball method) of 160 to 200° C. The preceding dicyclopentadiene type petroleum resin having a softening point (ring and ball method) of 160 to 200° C. includes petroleum resins which are high polymers containing a cyclopentadiene type component of 50% by weight or more and having a softening point (ring and ball method) falling in a range of 160 to 200° C. and which have a high softening point among petroleum resins obtained by polymerizing fractions comprising as principal components, at least one (hereinafter referred to as a cyclopentadiene type component) selected from cyclopentadiene, dicyclopentadiene, alkyl-substituted products and oligomers thereof and mixtures thereof which are obtained by steam cracking of petroleum naphtha, and hydrogenated dicyclopentadiene type petroleum resins having a softening point (ring and ball method) of 160 to 200° C. and an iodine value of 20 or less which are obtained by hydrogenating the resins containing a cyclopentadiene type component of 50% by weight or more among the petroleum resins described above under conditions of a temperature of 150 to 300° C. and a hydrogen pressure of 1 to 15 MPa in the presence of a solvent with a catalyst comprising metals such as vanadium, nickel and cobalt or an oxide thereof.

In the resin composition for the void-containing stretched film described above, the dicyclopentadiene type petroleum resin having a softening point (ring and ball method) of 160 to 200° C. is blended in an amount of 10 to 190 parts by weight, preferably 30 to 190 parts by weight and more preferably 50 to 190 parts by weight per 100 parts by weight of the crystalline polypropylene resin. If the blending amount is less than 10 parts by weight, brought about is the problem that the covering property turns unsatisfactory. On the other hand, if the blending amount exceeds 190 parts by weight, caused is the problem that breakage takes place very often to deteriorate the processing stability.

In the resin composition for the void-containing stretched film described above, 10 to 190 parts by weight of the inorganic filler powder is blended with 100 parts by weight of the crystalline polypropylene resin so that the total of the dicyclopentadiene type petroleum resin and the inorganic filler powder falls in a range of 20 to 200 parts by weight. If the blending amount of the inorganic filler powder is less than 10 parts by weight and the total of the dicyclopentadiene type petroleum resin and the inorganic filler powder is less than 20 parts by weight, the covering property is reduced. On the other hand, if the blending amount of the inorganic filler powder exceeds 190 parts by weight and the total of the dicyclopentadiene type petroleum resin and the inorganic filler powder exceeds 200 parts by weight, breakage tends to be liable to take place to deteriorate the processing stability in stretching a non-stretched film.

The inorganic filler powder used for the resin composition for the void-containing stretched film described above includes calcium carbonate, talc, titanium dioxide and silica each having an average particle diameter of 0.01 to 20 μm, preferably 0.01 to 10 μm and more preferably 0.1 to 5 μm, and calcium carbonate is advantageous from a viewpoint of a cost. They may be used alone or in combination of two or more kinds thereof.

In the ink jet recording paper of the present invention, when the void-containing stretched film which is the support is a void-containing laminated stretched film having an average surface roughness of 0.05 to 0.4 μm, preferably 0.05 to 0.3 μm, which is obtained by laminating a surface layer film comprising the crystalline polypropylene resin on both faces of a film comprising the resin composition for the void-containing stretched film described above, and then stretching it at an area magnification of 5 times or more, the ink jet recording paper having particularly a good surface smoothness is obtained, and therefore it is preferred. If the average surface roughness is less than 0.05 μm, blocking is caused on the void-containing laminated stretched film or the ink jet recording paper obtained from it, or glossiness is presented in excess in a certain case. On the other hand, if it exceeds 0.4 μm, a clearness of the print is likely to be reduced.

Various additives which are publicly known to be added to polypropylene, for example, phenolic antioxidants, thioether antioxidants,phosphorus antioxidants, higher fatty acid metal salts such as calcium stearate, lubricants such as fatty acid amides, pigments, foaming agents and polyethylenes and ethylene-propylene rubber as added polymers can be added, if necessary, to the resin composition for the void-containing stretched film described above and the resin composition for the surface layer film as long as the object of the present invention is not damaged.

The resin composition for the void-containing stretched film described above and the resin composition for the surface layer film can be prepared by stirring and mixing the crystalline polypropylene resin and the additives by means of an ordinary blender or mixer. Further, it can be molten, kneaded and pelletized as well by means of a conventional extruding machine.

In the present invention, publicly known methods such as a T-die film extrusion method and a blown film extrusion method can be given as examples of a method for obtaining a non-stretched single layer film from the resin composition for the void-containing stretched film described above. Further, publicly known laminate processing methods such as a co-extrusion method in which a molten resin is turned into a multilayer film in a die and an extrusion lamination method in which a surface layer film is further superposed on a base layer film prepared by extrusion are used as a method for obtaining a non-stretched laminated film from the resin composition for the void-containing stretched film and the resin composition for the surface layer film.

A stretching method for obtaining the stretched film from the non-stretched film described above and the stretching conditions shall not specifically be restricted. That is, it may be either monoaxial stretching or biaxial stretching, and it is preferably biaxial stretching. Both of publicly known monoaxial and biaxial stretching machines can be used.

The stretching conditions are different depending on a stretching machine used. The temperature is set to not higher than a softening point of the petroleum resin contained in the composition, and the film is stretched at an area magnification of 5 times or more. In the case of biaxial stretching, the area magnification is preferably 9 times or more.

In the case of a biaxial stretching machine, it may be either a simultaneous stretching system or a sequential stretching system.

In the ink jet recording paper of the present invention, when stiffness is required to the void-containing single layer stretched film which is the support, it is preferably a compression-treated void-containing single layer stretched film or a compression-treated void-containing laminated stretched film obtained by hot-compressing the void-containing single layer stretched film or void-containing laminated stretched film described above at a temperature of 50 to 160° C. and a pressure at which the voids do not disappear.

The hot-compressing described above can be carried out by means of a hot press or a hot-compressing roll.

With respect to the hot-compressing conditions, the void-containing single layer stretched film or void-containing laminated stretched film described above is heated up to 50 to 160° C. and then hot-compressed to a thickness of 50 to 90 based on a thickness of 100 before hot-compressing at a linear pressure of 0.5 to 4 kN/cm by means of a hot compressing roll. However, if the film is heated too high, the voids described above shall completely disappear, so that it has to be hot-compressed at a lower hot-compressing temperature than a temperature at which the voids disappear. Further, the voids disappear in a certain case by virtue of pressure, and therefore hot-compression has to be carried out on conditions on which restoration in a thickness direction and disappearance of the voids are not caused while controlling the temperature and the pressure.

In the ink jet recording paper of the present invention, a thickness of the void-containing stretched film which is the support shall not specifically be restricted and is preferably 25 to 300 μm. When the void-containing stretched film is a laminated film, a thickness of the base layer film accounts for 50% or more of a whole thickness of the laminated film.

A density of the void-containing stretched film described above shall not specifically be restricted, and 0.3 to 0.8 g/cm³ can be given as an example thereof.

In the ink jet recording paper of the present invention, an ink-receiving layer is formed on the surface of the void-containing stretched film which is the support. In the present invention, a method for forming the ink-receiving layer described above shall not specifically be restricted, and capable of being used is a method in which a publicly known coating agent for ink jet is coated on the surface of the void-containing stretched film which is the support and dried.

Known as the coating agent for ink jet are those provided with an ink-receiving layer comprising a pigment containing synthetic silica powder as a main component, a polyvinyl alcohol (including silanol-modified polyvinyl alcohol) water-based adhesive and a cationic polymer.

In the ink jet recording paper of the present invention, a method for coating the coating agent for ink jet shall not specifically be restricted, and it is formed by a method in which the coating agent is applied by, for example, air knife coating and blade coating and dried. A coating amount of the coating solution shall not specifically be restricted as well and is controlled usually in a range of 0.5 to 10 g/m² in terms of a dry weight.

In the ink jet recording paper of the present invention, capable of being suitably used are such various techniques publicly known in the ink jet recording paper production field that when the ink-receiving layer is formed only on one face of the void-containing stretched film which is the support, a face on which the ink-receiving layer is not formed is subjected to adhesive treatment to process the recording material into an adhesive label.

### EXAMPLES

The present invention shall specifically be explained below with reference to examples and comparative examples, but the present invention should not be restricted by them.

The following evaluation methods were used in the following examples and comparative examples.

(1) Ink Jet Printing Aptitude

Printing was carried out by means of an ink jet printer PM-700C (manufactured by Epson Co., Ltd.) to evaluate the following items.

Clearness

⊚: no vagueness is observed on a photographic image, and clearness is high, so that it is suited to a photographic image

X: vagueness is observed on a photographic image, and clearness is low, so that it is not suited to a photographic image

Opacity

⊚: highly white, and an opaque feeling is present, so that a photographic image is not seen through

X: lowly white, and an opaque feeling is short, so that a photographic image is seen through

(2) Average Surface Roughness (Ra; μm)

Surf Coder SE-30K manufactured by Kosaka Laboratory Co., Ltd. was used to determine an average surface roughness.

### Example 1

Preparation of Composition for Film

Put into a Henschel mixer (brand name) as resin components for a void-containing stretched film which was a base layer film of a laminated film were 0.2 part by weight of a phenolic antioxidant BHT (brand name), 0.1 part by weight of calcium stearate, 10 parts by weight of a dicyclopentadiene type petroleum resin (hereinafter referred to as DCPD) having a softening point of 172° C. and 10 parts by weight of calcium carbonate (average particle diameter: 1.5 μm) each based on 100 parts by weight of a crystalline polypropylene powder containing 96% by weight of a n-heptane-insoluble part and having an MFR of 2 g/10 minutes. They were mixed, stirred and then fed into a co-rotating type twin screw extruder to be molten and kneaded at 240° C. and extruded in the form of a strand. This was cooled down and cut to obtain a pelletized resin composition for a void-containing stretched film.

Put into the Henschel mixer (brand name) as resin components for a surface layer film of the laminated film were 0.2 part by weight of the phenolic antioxidant BHT (brand name) and 0.1 part by weight of calcium stearate each based on 100 parts by weight of a propylene-ethylene block copolymer powder having an MFR of 1.5 g/10 minutes, an ethylene concentration of 8% and a block index of 0.8%. They were stirred and then fed into a co-rotating type twin screw extruder to be molten and kneaded at 240° C. and extruded in the form of a strand. This was cooled down and cut to obtain a pelletized resin composition for a surface layer film.

Preparation of Void-containing Laminated Stretched Film

Used were a three-feed, three-layer film extruding apparatus equipped with a multilayer T-die (comprising one single screw extruder for a base layer having an aperture of 65 mmφ and two single screw extruders for a surface layer having an aperture of 50 mmφ) and a tenter method biaxial stretching machine, and fed were the resin composition for the void-containing stretched film described above into the single screw extruder for the base layer and the resin composition for the surface layer film described above into the single screw extruders for a surface layer. They were molten and co-extruded at a T-die temperature of 240° C., followed by quenching it on a specular cooling roll having a surface temperature of 30° C. to obtain a two-feed, three-layer non-stretched film in which a surface layer, a base layer and a surface layer were laminated in this order in a thickness ratio 1:3:1. The non-stretched film thus obtained was introduced into a stretching machine to be stretched by 5 times in machine direction(a flow direction of the resin) at a temperature of 140° C. between hot rolls and then stretched by 8 times in transverse direction at a tenter temperature of 160 to 210° C., and then it was rolled up to obtain a void-containing laminated stretched film having a total thickness of 120 μm and an average surface roughness of 0.05 μm.

Coating of a Coating Agent for Ink Jet

A 9% aqueous solution of a coating agent CM-318 for ink jet (a coating agent for ink jet manufactured by Kuraray Co., Ltd.) was coated on one face of the void-containing laminated stretched film described above by means of a rod of #14 and dried at 100° C. for 5 minutes to obtain an ink jet recording paper sample. The coating amount was 2.9 g/m² in terms of a dry weight.

Evaluation Test

This ink jet recording paper sample was subjected to conditioning in a room of 23° C. and a humidity of 50% for whole day and night and then used for evaluating a printing aptitude. The evaluation results thereof are shown in Table 1.

### Examples 2 and 3

Preparation of Composition for Film

Resin compositions for a void-containing stretched film and resin compositions for a surface layer film were obtained according to the method described in Example 1, except that the blending amounts of DCPD and calcium carbonate which were blended with the resin composition for the void-containing stretched film which was the base layer film in the laminated film were changed as shown in Table 1.

Preparation of Void-containing Laminated Stretched Film

The composition described above was used to obtain a void-containing laminated stretched film sample having a thickness of 120 μm and an average surface roughness shown in Table 1 according to the method described in Example 1.

The coating agent for ink jet was coated on this film sample according to the method described in Example 1 and dried, and the resulting ink jet recording paper sample was subjected to the evaluation test. The evaluation results thereof are shown in Table 1.

Comparative Examples 1 and 2

Void-containing laminated stretched film samples were prepared according to the method described in Example 2, except that the blending amounts of DCPD and calcium carbonate which were blended with the resin composition for the void-containing stretched film were changed as shown in Table 1. The coating agent for ink jet was coated on the film samples according to the method described in Example 1 and dried, and the resulting ink jet recording paper samples were subjected to the evaluation test. The evaluation results thereof are shown in Table 1.

### Comparative Example 3

A void-containing laminated stretched film sample was prepared according to the method described in Example 1, except that the blending amounts of DCPD and calcium carbonate which were blended with the resin composition for the void-containing stretched film were changed as shown in Table 1. The coating agent for ink jet was coated on the film sample according to the method described in Example 1 and dried, and the resulting ink jet recording paper sample was subjected to the evaluation test. The evaluation results thereof are shown in Table 1.

Effects of the Invention

The ink jet recording paper of the present invention can provide a printed matter which is excellent in clearness and opacity and can suitably be used as a recording paper on which photographic image informations received in the form of digital information through a scanner are printed by means of an ink jet printer.

TABLE 1

| | | | Comparative | | |
|---|---|---|---|---|---|
| Example | | | Example | | |
| 1 | 2 | 3 | 1 | 2 | 3 |

Composition of base layer
film

| | | | | | | |
|---|---|---|---|---|---|---|
| Crystalline polypropylene | 100 | 100 | 100 | 100 | 100 | 100 |
| weight part | | | | | | |
| DCPD weight part | 10 | 50 | 100 | 5 | 150 | 0 |
| Calcium carbonate weight part | 10 | 50 | 100 | 5 | 150 | 100 |
| Surface roughness (Ra) μm | 0.05 | 0.12 | 0.30 | 0.03 | 0.52 | 0.21 |
| Ink jet printing aptitude | | | | | | |
| Clearness | ⊚ | ⊚ | ⊚ | ⊚ | X | ⊚ |
| Opacity | ⊚ | ⊚ | ⊚ | X | ⊚ | X |

What is claimed is:

1. An ink jet recording paper comprising a void-containing stretched film comprising a crystalline polypropylene resin and a dicyclopentadiene type petroleum resin as essential components and an ink receiving layer formed on a surface thereof.

2. The ink jet recording paper as described in claim 1, wherein the void-containing stretched film is a void-containing laminated stretched film having an average surface roughness of 0.05 to 0.4 μm, which is obtained by laminating a surface layer film comprising a composition of the crystalline polypropylene resin at least on one face of a base layer film comprising a resin composition prepared by blending 10 to 190 parts by weight of the dicyclopentadiene type petroleum resin having a softening point (ring and ball method) of 160 to 200° C. and 10 to 190 parts by weight of an inorganic filler powder with 100 parts by weight of the crystalline polypropylene resin so that the total amount of the dicyclopentadiene type petroleum resin and the inorganic filler powder is 20 to 200 parts by weight, and then stretching it at an area magnification of 5 times or more.
